(19) United States
(12) Patent Application Publication
(10) Pub. No.: US 2024/0097913 A1
(43) Pub. Date: Mar. 21, 2024

(54) TRANSMISSION OF SIGNATURES USED IN STATEFUL SIGNATURE SCHEMES

(71) Applicant: HEWLETT-PACKARD DEVELOPMENT COMPANY, L.P., Spring, TX (US)

(72) Inventors: Thalia May Laing, Bristol (GB); Maugan Villatel, Bristol (GB); Adrian Shaw, Bristol (GB); Adrian John Baldwin, Bristol (GB); Pierre Belgarric, Bristol (GB)

(73) Assignee: HEWLETT-PACKARD DEVELOPMENT COMPANY, L.P., Spring, TX (US)

(21) Appl. No.: 18/452,798

(22) Filed: Aug. 21, 2023

(30) Foreign Application Priority Data
Sep. 16, 2022 (GB) 2213629.5

(51) Int. Cl. H04L 9/32

(52) U.S. Cl. CPC H04L 9/3247

(57) ABSTRACT

In an example, a computing device is described. The computing device comprises a communication interface and a processor. The processor is to determine whether a signature, produced by a signer, is derived from a free state under a stateful signature scheme. The free state is a state that has not been used as an input to generate a signing key. The signature is encrypted by the signer. The processor is further to, in response to determining that the signature is derived from a free state, decrypt the encrypted signature. The processor is further to transmit the decrypted signature to a recipient via the communication interface.

### BACKGROUND

A cryptoprocessor may use a private key to sign data. A verifier may use a public key associated with the private key to verify that the data was signed by the cryptoprocessor.

### BRIEF DESCRIPTION OF DRAWINGS

Non-limiting examples will now be described with reference to the accompanying drawings, in which:

FIG. 1 is a schematic drawing of an example computing device to transmit a signature in a stateful signature scheme;

FIG. 2 is a flowchart of an example method of transmitting a signature in a stateful signature scheme;

FIG. 3 is a flowchart of an example method of transmitting a signature in a stateful signature scheme;

FIG. 4 is a flowchart of an example method of transmitting a signature in a stateful signature scheme;

FIG. 5 is a schematic drawing of an example computing device to use a signature transmitted in a stateful signature scheme;

FIG. 6 is a schematic drawing of an example computing device to use a signature transmitted in a stateful signature scheme;

FIG. 7 is a schematic drawing of an example computing device to transmit a signature in a stateful signature scheme; and

FIG. 8 is a schematic drawing of an example computing device to transmit a signature in a stateful signature scheme.

### DETAILED DESCRIPTION

Disclosed herein are computing devices, machine readable media and methods involved in transmission of signatures in a stateful signature scheme.

As used herein, a stateful signature scheme refers to use of a function (e.g., a hash function in a stateful hash-based signature scheme) to construct a one-time signature (OTS) private key for use by a signer to produce a signature under the scheme. Such a signature scheme is considered stateful by virtue of the OTS private key generated under the scheme being single-use and ensuring that the OTS private key is not ever reused to sign data. Reusing an OTS private key of a stateful signature scheme may destroy the security of the scheme.

It may be necessary to prepare for the possibility that a signer such as a cryptoprocessor holding a private seed value used for generating an OTS private key may fail during the lifetime of the signer by introducing resiliency to the signing ecosystem. This may be relevant if the private seed value is to be used to generate OTS private keys over a long time period and/or replacing the associated public key would be difficult.

A copy of the private seed value and a latest state used as an input to generate an OTS private key could be stored in a secure alternate location. However, simply copying the private seed value and the state may create a risk of state reuse, thereby destroying the security. In an example scenario where a signer has a private seed value and a state, these two values may have been backed up on an alternative device. The signer may increment the state, sign a message and then fail, losing both the private seed value and latest state (e.g., the latest counter value). The signer may then recover the key from the backup, which holds the previous, non-updated state, thus resulting in state reuse next time the signer signs, resulting in loss of all security.

Examples described herein provide an approach to provide resiliency in a stateful signature scheme whilst removing the chance of state reuse. In an example, a signer may speculatively produce a signature using an OTS private key derived from a state selected by the signer. In an example, the signer may not know whether the state has already been used to produce a signature. A state manager may receive the signature in such a way that the state manager can control whether to release the signature to a verifier based on the state manager's knowledge on whether the state used to derive the signature is a free state or not. The verifier may not be able to access the content of the signature unless the state manager releases the signature. In the case that the state has not already been used (such that the state can be considered to be a free state), the signature can be released to the verifier by the state manager. In the case that the state has already been used (such that the state is not considered to be free), releasing the signature could destroy the security of the scheme. Thus, the state manager may ensure that even if a signer reuses a state to derive a signature, the signature may not reach the verifier in a form that allows the security of the signature scheme to be compromised.

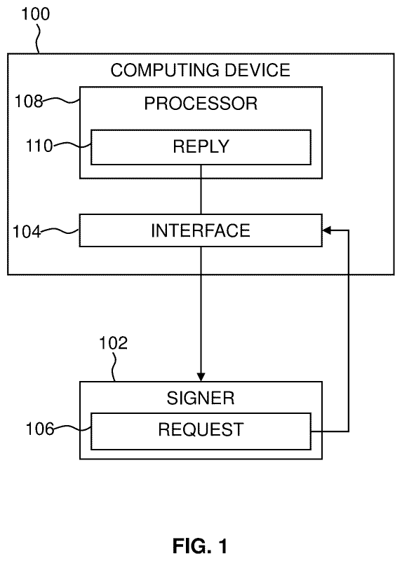

FIG. 1 is a schematic drawing of an example computing device 100 to transmit a signature in a stateful signature scheme. The computing device 100 may implement the functionality of a state manager of the stateful signature scheme, as described in more detail below.

The computing device 100 comprises a communication interface 102 and a processor 104. In some examples, the processor 104 may have access to instructions (e.g., stored in the computing device 100) readable and executable by the processor 104 to implement the functionality described herein.

The communication interface 102 is to transmit or receive data to/from an entity such as a signer or a recipient of a message signed by the signer.

Such a signer 106 and recipient 108 are also shown in FIG. 1. As explained below, the computing device 100 may control whether a signature 110 produced by the signer 106 can be received or interpreted by the recipient 108 in such a way that prevents state reuse under the stateful signature scheme.

The computing device 100 may interact with the signer 106, which may be an entity that is trusted to sign data (e.g., a message).

An example implementation may be that the signer 106 is to provide a signing function as part of a computing infrastructure to provide updates. Such computing infrastructure may be set up to transmit a message comprising a software or firmware update to a recipient such as a user device (e.g., a laptop, phone, tablet, Internet-of-Things (IoT) device, printer or other hardware). In this example implementation, the signer 106 may be a hardware security module (HSM) of the computing infrastructure and the HSM is to sign the message comprising the update using an OTS private key under the stateful signature scheme. Thus, the recipient may receive an authentication path from the signer 106, as part of the signature, to facilitate verification of the message.

Upon the signing procedure being completed the (signed) message may be sent to the recipient 108, which may allow the recipient 108 to verify the message is authentic (e.g., it originated from a trusted source) so that the recipient 108 may proceed to implement the software or firmware update according to the code. Some examples of how the message may be sent to the recipient 108 are described below.

The processor 104 is to determine whether a signature 110, produced by the signer 106, is derived from a free state under a stateful signature scheme. The free state is a state that has not been used by the signer 106 as an input to generate a signing key (used to produce the signature 110).

A free state may refer to a state under the stateful signature scheme that has not been used by any signer under the stateful signature scheme to generate a signing key. Thus, the free state may be considered to be an available state of the stateful signature scheme.

Using a state that is not free to produce a signature (where that signature can be received by an entity such as the recipient 108) destroys the security of the stateful signature scheme. However, the signer 106 may not be aware of which states under the stateful signature scheme are free. This may be the case if the signer 106 is not able to prevent reuse of states such as where it is not appropriate or possible for the signer 106 to have knowledge of which states have been used by any signer under the stateful signature scheme e.g., where there are multiple signers under the same stateful signature scheme.

The signer 106 may choose to use any state under the stateful signature scheme to derive a signing key to produce the signature 110. However, there is a risk that the signer 106 could produce a signature 110 using a state that is not free (e.g., because it has been used by another signer). For this reason, the signature 110 (which could either be derived from a free state or not derived from a free state because the signer 106 may not be aware of which states are free) is encrypted by the signer 106 (to the computing device 100). In this manner, even if an entity (other than the computing device 100) receives the signature 110, the entity is unable to perform signature verification because the signature 110 is encrypted. The encryption of the signature 110 may prevent security being destroyed in case the signature 110 was generated using a signed key derived from a state that is not free. In other similar words, the functionality of the computing device 100 may prevent the entity such as the recipient 108 from being able to perform signature verification if it receives the signature 110 directly.

In some examples, the computing device 100 may maintain its own record (e.g., a database) of free states under the stateful signature scheme. The processor 104 is to determine whether the signature 110 is derived from a free state (i.e., that the signing key used by the signer 106 to produce the signature 110 is derived from a free state) by checking such a record. The database may be updated by the computing device 100 in response to determining that a state has been used and is therefore no longer free under the stateful signature scheme.

The signature 110 or data provided with the signature 110 may allow the state used to produce the signature 110 to be determined by the processor 104. Once the state associated with the signature 110 is established, the processor 104 can decide to release the signature 110 to the recipient 108.

Thus, in response to determining that the signature 110 is derived from a free state, the processor 104 is to decrypt the encrypted signature 110. As noted above, the signature 110 is encrypted to the computing device 100 meaning that the computing device has the relevant decryption key needed to decrypt the signature 110. In some examples, the decryption key is a symmetric key (either shared during setup or established using an asymmetric scheme such as a key agreement scheme). In some examples, the decryption key is a private key of an asymmetric encryption scheme.

Further, the processor 104 is to transmit the decrypted signature 112 to the recipient 108 via the communication interface 102.

In some examples, the recipient 108 may then perform signature verification on the decrypted signature 112. Note that the recipient 108 and signer 106 are depicted as separate entities in FIG. 1. However, in some examples as described in more detail below, the signer 106 may be the recipient 108 of the decrypted signature 112 (which could then be sent to another entity to perform verification of a signed message produced by signer 106).

In some examples, the signature 110 could be decrypted in order to determine the state used to derive the signing key. If the state is not free, the decrypted signature 112 is not transmitted (e.g., the signature 112 may be deleted). In some examples, the signature 110 does not need to be decrypted to determine the state because the signature 110 or accompanying data may already be in a form to allow the processor 104 to determine the state. In either case, the computing device 100 may be trusted to not transmit the decrypted signature 112 if the state used to produce the signature 110 is not a free state.

It may be considered that the selection of the state by the signer 106 is speculative because the signer 106 may not have knowledge of whether the state is free. In some examples, the signer 106 may maintain its own record of used states (i.e., the states that the signer 106 has already used to generate signing keys). Thus, the signer 106 may speculatively produce the signature 110 based on its own assumption about free states.

In some examples, the signer 106 may have used a free state, in which case the computing device 100 may decrypt the signature 110. However, in some examples the signer 106 may have used a state that is not free, in which case the computing device 100 does not transmit the decrypted signature 112 and the signer 106 may have to re-attempt signing with another signing key (based on another speculatively selected state).

Some examples of how the signer 106 may generate a signing key are now described.

In some examples, the key (i.e., the signing key) is generated by inputting a seed (e.g., a private seed value from the seed key pair of a stateful signature scheme) and an available state (such as an unused value within the state space of the stateful signature scheme) to a key generator (also referred to herein as a key generation function). The key generator is implemented by the signer 106. The resulting key may be referred to as a one-time use private key (e.g., an OTS private key the Leighton-Micali Hash-based Signature Scheme (LMS), where the state used to generate the OTS private key is known as the leaf number in LMS). Ensuring that an OTS private key is used once (since the state is unique and not reused to generate a key) may maintain statefulness of a stateful signature scheme.

Example stateful hash-based signature schemes such as the Leighton-Micali Hash-based Signature Scheme (LMS) and the eXtended Merkle Signature Scheme (XMSS) specify that the signer is to maintain a state, which updates every time a signature is produced. The state is chosen from a finite set. For example, the state may be a counter which runs from 0 to 2²⁰−1 for a Merkle tree of height 20 (where the tree height defines the number of states that are initially available under the stateful signature scheme prior to signing any messages). This state is used in conjunction with a private seed value to produce a one-time signing (OTS) private key, which is used to produce a signature. If the state, and therefore the OTS private key, is repeated and used to sign two distinct messages, the security of the scheme collapses. Thus, state management is a relevant consideration for maintaining the security of the scheme. In the examples of LMS and XMSS, the state is a counter (normally used in order e.g., starting at 0, 1, 2 and so on). As the number of states is finite, there is an upper bound on the number of signatures that can be produced for a given seed key pair (comprising a private seed value/key and an associated public key) and this upper bound is to not be exceeded.

In LMS, the seed used to derive the OTS private key is known as the signing key. Thus, any reference herein to a seed or private seed value may refer to a signing key in the context of LMS. However, as used herein, any reference to a key or signing key (in the context of producing a signature) may refer to an OTS private key such as used in LMS.

In some examples, the key generator is to generate the one-time use private key using a pseudorandom function (PRF). In some examples, an OTS private key may be generated from a seed (e.g., one_time_private_key=f(seed, i), where “i” is the state), where the function “f” may implement a PRF and/or a key derivation function (KDF) such as a hash-based message authentication code (HMAC)-based KDF (HKDF). However, any appropriate pseudorandom method may be implemented to generate the OTS private key from the seed and the state.

The computing device 100 (and the related examples described herein) may facilitate resiliency of a private seed value associated with a stateful signature scheme implemented by multiple signers whilst removing the chance of state reuse. The multiple signers, which may have the same private seed value (to offer resiliency), may avoid the risk of state reuse since the computing device 100 may manage the states. In some examples, the signers may maintain their own record of the states that they have individually used but may not have knowledge of the state maintained by other signers. The encryption of the signature 110 may ensure that a secure channel (which may be confidential and integrity protected) is provided between each signer and the computing device 100 so that the computing device 100 can control whether or not to release a decrypted signature 112 representative of the signature 110. In this manner, the complexity associated with distributing states between multiple signers may be reduced while maintaining statefulness of the stateful signature scheme.

In some examples, if the signer 106 wishes to sign a message using a key generated from a private seed value (associated with the stateful signature scheme), the signer 106 may either randomly generate a value to act as the state or retrieve their locally maintained state. The state is used as an additional input to the key generator alongside the private seed value to generate the key. Since the signer 106 does not know if this state is available under the stateful signature scheme, it can be considered to be a speculative selection of state. The resultant signature 110 is encrypted to the computing device 100, which makes the decision over whether to decrypt the signature 110 based on the state used to generate the signing key. The computing device 100 may determine the state from the signature 110 itself or from data sent alongside the signature 110.

The computing device 100 may be responsible for verifying the integrity of the state and determining whether this state has been used before. In some examples, the state indicated by signature 110 or accompanying data may be integrity protected (e.g., using an additional signature or message authentication code (MAC) applied by the signer 106) in case the state has been modified (e.g., if the indicated state was not itself encrypted by the signer 106) during transit by an attacker.

This computing device 100 may introduce resiliency into a stateful signature scheme such as a stateful hash-based signature scheme without risking state reuse. Although the computing device 100 provides a state management function, the computing device 100 may not need to store a copy of the private seed value. Instead, the computing device 100 may store a relevant decryption key to permit decryption of the signature 110. In some examples, the decryption key may be stateless and could be backed-up in an alternate location. In some examples, the computing device 100 may store a table of which states have been used, but this information may not need to be private.

The ability to manage states under a stateful signature scheme in accordance with certain examples described herein such that multiple signers may attempt to use an available state without risking state reuse (by any of the signers) may avoid the need to implement a more complex backup system, which may involve producing large signatures as a result of there being multiple signers. Using the computing device 100 to manage the state space may allow smaller signatures to be produced for a given size of the state space underpinning the stateful signature scheme. In some examples where a recipient of a signed message is resource constrained, such as may be the case in a secure boot procedure implemented by the recipient 108, the recipient 108 may need less time to perform signature verification as a result of the small signature size.

In some examples, to facilitate verification of a signed message, the signer 106 may send the (one-time) signature and information (i.e., an authentication path) needed for verifying the signature to allow the recipient 108 to verify that a candidate public key derived from the signature is contained in a Merkle tree. The authentication path for a given state indicates the nodes and/or public keys contained in the Merkle tree for the stateful signature scheme to allow a root public key for the stateful signature scheme to be computed.

In some examples, to verify the signed message, the recipient 108 may receive the signed message and compute a candidate OTS public key. The recipient 108 can then verify that the candidate OTS public key is contained in the Merkle tree with the public key as its root node. In this regard, the recipient 108 may compute a candidate OTS public key from the signature and the message. Using the state value and the authentication path, the recipient 108 may verify that the candidate OTS public key is contained in the Merkle tree with the public key as its root node. If the verification procedure is successful, the recipient 108 accepts the signature as valid and the message as authentic.

In some examples, the signer 106 may comprise a cryptoprocessor (e.g., a signer) to perform a cryptographic operation such as signing data with a private key, encrypting data, etc. A cryptoprocessor may implement a level of security that specifies whether the cryptoprocessor is to do anything with data stored therein (e.g., keying material) in response to an event such as a physical attack on the cryptoprocessor. The level of security specified for the cryptoprocessor may depend on the use case of the cryptoprocessor.

Examples of cryptoprocessors (sometimes referred to as secure cryptoprocessors) that may implement a physical security mechanism include devices such as a cryptographic module or hardware security module (HSM). In some examples, the level of security provided by a cryptoprocessor may comply with a standard such as specified by the Federal Information Processing Standards (FIPS) Publications 140-2 or 140-3.

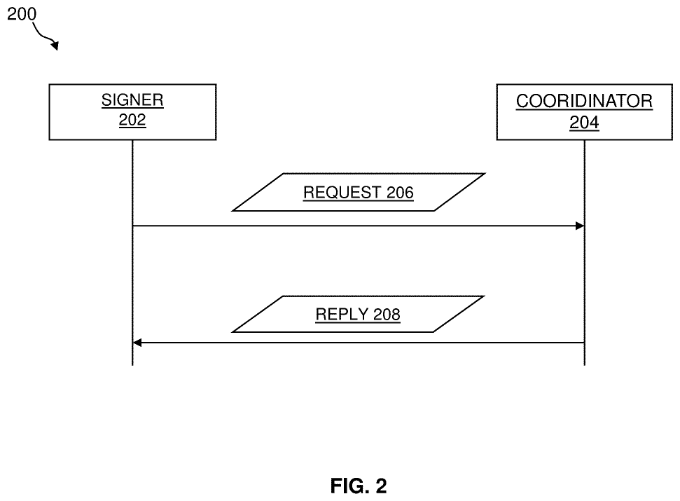

FIG. 2 is a flowchart of an example method 200 of transmitting a signature in a stateful signature scheme. In some examples, a part of the method 200 may be implemented by the computing device 100 or other computing devices or machine-readable media described herein. The flowchart depicts interactions between a state manager 202, a signer 204 and a verifier 206. The state manager 202 may implement the functionality of the computing device 100 of FIG. 1 and/or related examples. The signer 204 may implement the functionality of the signer 106 of FIG. 1 and/or related examples. In some examples, the verifier 206 may implement the functionality of the recipient 108 of FIG. 1.

In the method 200, the signer 204 transmits an encrypted signature 208 to the state manager 202. In some examples, the encrypted signature 208 may correspond to the encrypted signature 110 of FIG. 1. If the state used to generate the signing key to produce the signature 208 (e.g., prior to encryption) is determined to be a free state (by the state manager 202), the state manager 202 decrypts the signature 208 and transmits the decrypted signature 210 to the verifier 206.

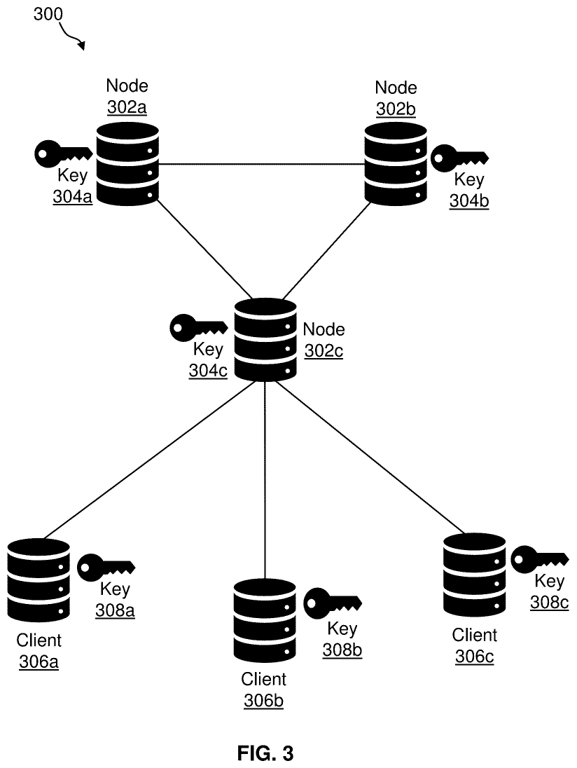

FIG. 3 is a flowchart of an example method 300 of transmitting a signature in a stateful signature scheme. In some examples, a part of the method 300 may be implemented by the computing device 100 or other computing devices or machine-readable media described herein. Reference numerals for features of the method 300 that are similar to or have corresponding functionality to features of the method 200 of FIG. 2 are incremented by 100. In this regard, the method 300 implements the same functionality as the method 200 and further functionality as described by the examples below. The flowchart depicts interactions between a state manager 302, a signer 304 and a verifier 306. These entities correspond to the entities described in relation to FIG. 2.

In the example method 300, the message signed by the signer 304 is also transmitted by the signer 304 to the state manager 302 along with the encrypted signature 308. Further, if the signature 308 is decrypted by the state manager 302, the message 15 may also be sent by the state manager 302 to the verifier 306 along with the decrypted signature 310. Thus, in the method 300, the message that was signed by the signer 304 is forwarded by the state manager 302 along with the decrypted signature 310.

As indicated by comparing the method 200 of FIG. 2 with the method 300 of FIG. 3, in some examples, the message may not necessarily be forwarded by the state manager 202 to the verifier 306, as discussed in more detail below.

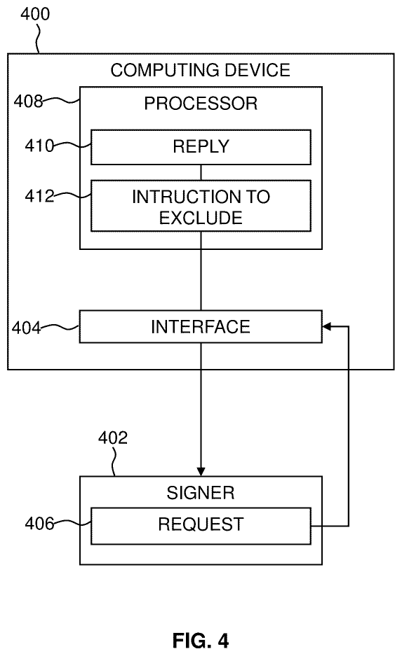

FIG. 4 is a flowchart of an example method 400 of transmitting a signature in a stateful signature scheme. In some examples, a part of the method 400 may be implemented by the computing device 100 or other computing devices or machine-readable media described herein. Reference numerals for features of the method 400 that are similar to or have corresponding functionality to features of the method 200 of FIG. 2 are incremented by 200. In this regard, the method 400 implements the same functionality as the method 200 and further functionality as described by the examples below. The flowchart depicts interactions between a state manager 402, a signer 404 and a verifier 406. These entities correspond to the entities described in relation to FIG. 2 and FIG. 3.

In some examples, the message 412 is not sent by the signer 404 to the state manager 402. The encrypted signature 408 is sent from the signer 404 to the state manager 402. This is similar to what is depicted by FIG. 2. The message 412 itself is sent directly from the signer 404 to the verifier 406. In addition, the decrypted signature 410 is transmitted from the state manager 402 to the verifier 406. In some examples, the message 412 is sent by the signer 404 to the state manager 402 (as well as being sent to the verifier 406) e.g., so that the state manager 402 can verify the signature 408 on the message 412. Thus, the message 412 may or may not be sent alongside the signature 408 to the state manager 402 (e.g., in addition to being sent from the signer 404 to the verifier 406).

In some examples, the decrypted signature 410 is transmitted directly from the state manager 402 to the verifier 406. The signer 404 may send the message 412 at any time (e.g., before or after the decrypted signature 110 is sent).

In some examples, the decrypted signature 410 is transmitted indirectly from the state manager 402 to the verifier 406 e.g., via the signer 404. The signer 404 may send the message 412 at any time (e.g., before or after the decrypted signature 410 is sent). However, in some examples, the receipt of the decrypted signature 410 by the signer 404 may trigger the release of the message 412 and associated forwarding of the decrypted signature 410.

Once the verifier 406 has both the decrypted signature 410 and the message 412, the verifier 406 may perform signature verification. Transmitting the signature 410 and message 412 separately (e.g., rather than forwarding in the same transmission as described above) may reduce network traffic and/or reduce load on the state manager 302.

Further implementation details that may be relevant to the methods 200, 300 and/or 400 are described below.

Examples described here may involve use of a state manager to ensure that multiple signers maintain statefulness of a stateful signature scheme, even if the signers use a state that is not free under the stateful signature scheme. In some examples, there may be a single state manager. In some examples, the state manager may have a database of all possible free states under the scheme. In some examples, the state manager may keep track of which states have been used and which have not been used. The state manager may not have a copy of the private seed value but may have a copy of a public key for the signers. The state manager may have a secure communication channel with each of the signers. Details of example secure communication channels are provided below.

A description of an example signature procedure (e.g., implemented by the signer 106) is provided below with reference to the entities, features and functionality described in relation to FIG. 1.

If the signer 106 has a message that they wish to sign, the signer 106 may speculatively select a state. In some examples, the signer 106 may maintain a database of which states they have used previously, or the signer 106 may use states in an ordered way to avoid personally repeating a state. In some examples, the signer 106 may generate a random value to use as the state.

In some examples, once the signer 106 has chosen a state, the signer 106 is to use the state and the private seed value as an input to a key generator, f, to produce a one-time signature (OTS) private key according to f(seed, state)=OTS private key (e.g., as per a stateful signature scheme such as the hash-based stateful signature scheme). The signer 106 is to use the OTS private key in a stateful signature scheme to produce a stateful signature. The signer 106 may then communicate both the state used and the signature produced to the computing device 100 in a secure manner. In this regard, the signature may be communicated to the computing device 100 in a confidential manner e.g., using a (symmetric or asymmetric) encryption scheme. In some examples, the state may be communicated to the computing device 100 in an integrity protected way. Such integrity protection may be achieved by using a message authentication code (MAC) or an alternative signature scheme. For the purpose of the present discussion, it can be assumed that the state is integrity protected. The scenario where the state is not integrity protected is discussed below.

In some examples, upon receiving the encrypted signature 110 and the state (noting that in some examples, the state may be within the signature 110 or within data accompanying the signature 110) from the signer 106, the computing device 100 may verify the integrity of the state.

In some examples, if the computing device 100 is satisfied with the integrity of the state, the computing device 100 may check its local database to see if the state has been used previously.

If the state has been used previously, the computing device 100 may delete the decrypted signature 112 (i.e., if the encrypted signature 110 has been decrypted) and terminate. In some examples, the computing device 100 may respond to the signer 106 and inform them that the state they signed with has previously been used. If the signer 106 maintains a local state, the signer 106 may record this information and avoid reusing this state in the future. In some examples, the signer 106 may restart the signing procedure and try producing a signature with a new state.

If the state has not been previously used to produce a signature (by any signer), the computing device 100 records the state in the database as having been used, and hence not free.

In some examples, the computing device 100 may decrypt the encrypted signature 110 in response to determining that the signature 110 was produced based on a free state. In some examples, the decryption may need to be performed prior to determining the state (e.g., if the state is encrypted). However, the computing device 100 may delete the decrypted signature 112 to prevent release of the signature 112 if the state used to produce the signature 110 was not a free state.

In some examples, the computing device 100 may verify the signature 110 using the state and a public key of the signer 106 e.g., to ensure that the signature was computed with the declared state. This may protect against errors on the signer's 106 behalf. If the signature verification fails, the computing device 100 may delete the decrypted signature 112 (i.e., if the encrypted signature 110 has already been decrypted) and terminate. If the signature verification is successful, the computing device 100 may proceed.

In response to decrypting the signature 110 and being assured that the state used to produce the signature 110 is a free state (and, if necessary, establishing that its integrity can be verified), the computing device 100 may have the assurance the signature 110 was produced with a free state and may release the decrypted signature 112 for consumption by third parties e.g., a verifier that is the intended recipient of the message so that the verifier can perform signature verification.

In some examples, if the state is not integrity protected as described above, the state may be vulnerable to being manipulated in transit. For example, a signer may produce a signature and send the signature to the state manager where the signature comprises both the encrypted signature 110 and the state, i. An eavesdropper may recognize that state i has been previously used (and is not free) and, in an attempt to learn multiple (plaintext) signatures produced using the same state, manipulate the state=i to be a fresh value (such as state=i+1), in the hope that the computing device 100 may decrypt and release the signature. To protect against such attacks, if the state is not integrity protected, the computing device 100 may verify the signature to ensure that the recorded state is, in fact, the state used to produce the signature. It is to be noted that if the computing device 100 (or any verifier) tries to verify a signature with the incorrect state, the signature does not verify successfully, which may prevent attacks such as described above.

In some examples, the signer 106 may choose a set of x states and sign the same message x times with each state and send all x signatures to the computing device 100. The computing device 100 may then choose which of the states and corresponding signatures to decrypt and use, destroying the others. This approach may increase the chance of the signer 106 choosing an unused state and reduce the communication rounds before a signature with a unique state is decrypted (rather than the computing device 100 informing the signer of accidental state reuse and the signer 106 having to attempt to sign based on a different state).

The recipient 108 may perform signature verification on the decrypted signature 112 to ensure that it trusts the message.

As described above, there may be a secure channel between the computing device 100 and the signer 106 (and any other signers). A secure channel may be achieved in a number of ways.

In some examples, the computing device 100 may have an asymmetric encryption key pair, for which each signer 106 is given the public key. The signers 106 ensure they have the correct public key for the computing device 100.

In some examples, a set of signers 106 and the computing device 100 may all share a symmetric key of a symmetric encryption scheme.

In some examples, each signer 106 may share a (unique) symmetric key with the computing device 100. Every signature 110 produced by the same signer 106 is encrypted using the same encryption key, however signatures produced by different signers are encrypted using different keys. This approach may facilitate signer revocation in case of a signer failing or being attacked.

In some examples, each signer 106 may share a symmetric key with the computing device 100, from which the signer 106 derives another key according to the state that has been used. Signatures produced by the same signer and with the same state are to be encrypted under the same key. For example, the computing device 100 may generate a master key: MK. The computing device 100 may then use a key derivation function (KDF, such as HKDF) to derive a per-signer symmetric key: SKj=KDF(MK, signer_j). The computing device 100 shares SKj with signer j. When the signer produces a signature with state i, the signer is to use a KDF to generate a seed-specific key: Skji=KDF(SKj, state=i). The signer is to then use SKji to encrypt the signature created with state i. If the computing device 100 decrypts the signature, the computing device 100 is to generate the key SKji from SKj, which could be derived from MK.

These different key architectures for securing communication between the signers and the state manager may have different trade-offs.

For example, in the case where each signer 106 shares a symmetric key with the computing device 100 from which the signer 106 derives another key according to the state that has been used, the computing device 100 may generate an incorrect key if the state is unprotected in transit and modified (since the wrong state is used as an input when the computing device 100 generates the key). By generating an incorrect key, the computing device 100 may therefore be unable to decrypt the signature 110. This approach may be more secure than having the computing device 100 hold a plaintext signature computed with a repeated state in memory while it verifies it. This approach may facilitate signer revocation in case of a signer failing or being attacked.

In some examples, approaches that involve use of symmetric keys to provide a secure channel may not need to use a quantum secure encryption scheme whereas the approach that involves use of asymmetric keys may need to use a specified quantum-secure encryption scheme such as CRYSTALS-Kyber.

As highlighted above, there may be various ways for the signer 106 to send the state to the computing device 100.

In some examples, the state may be encrypted as well as the signature 110. For example, the signature 110 may include the state. Such a signature 110 including the state may then be encrypted. In another example, the state may be separate to the signature and then both the state and the signature may be encrypted (e.g., using the same or a different key).

In some examples, the state may be sent unprotected e.g., via data accompanying the signature 110. However, the state may need to be integrity protected as explained above.

In some examples, the state may be sent signed, using a different signature scheme to the stateful signature scheme.

In some examples, the state may be secured using a MAC, produced using a symmetric key, which could be based on any of the symmetric key architectures described above.

Some further examples relating to the above are now described.

In some examples, the processor 104 is to, in response to determining that the signature 110 is not derived from a free state, delete the decrypted signature 112.

In some examples, the signature 110 is to facilitate verification of a message signed with the signature 110 by the signer 106.

In some examples, the message is received via the communication interface 102 along with the encrypted signature 110. The processor 104 may, in response to determining that the signature 110 is derived from a free state, instruct transmission of the message via the communication interface 102 to the recipient 108 (e.g., such as in the manner described in relation to the method 300 of FIG. 3).

In some examples, the processor 104 is to, in response to determining that the signature 110 is derived from a free state, instruct the signer 106 to transmit the message to the recipient 108 (e.g., such as in the manner described in relation to the method 400 of FIG. 4).

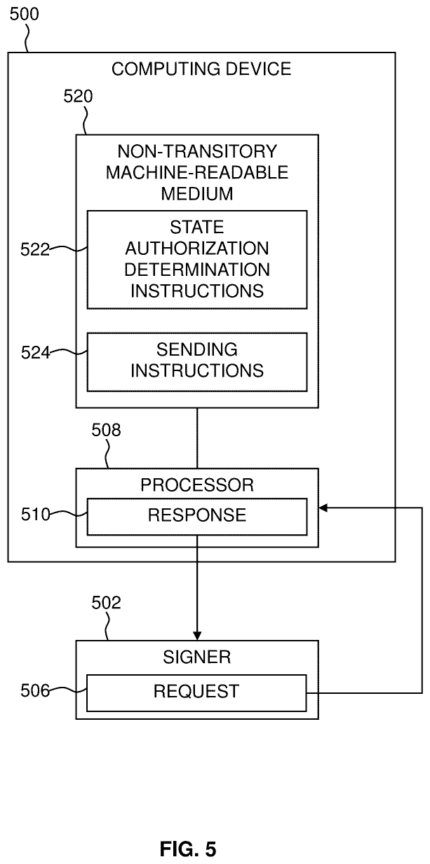

FIG. 5 is a schematic drawing of an example computing device 500 to use a signature transmitted in a stateful signature scheme. Reference numerals for features of the computing device 500 that are similar to or have corresponding functionality to features of the computing device 100 of FIG. 1 are incremented by 400. The computing device 500 may implement similar functionality to the computing device 100 (and provide similar technical results as described previously). Thus, further details of the features of the computing device 500 with similar functionality to the features of the computing device 100 can be understood with reference to the description of the computing device 100 and related examples.

The computing device 500 comprises an interface 502, a processor 504 and a non-transitory machine-readable medium 520.

As used herein, the term “non-transitory” does not encompass transitory propagating signals.

The non-transitory machine-readable medium 520 stores instructions readable and executable by the processor 504. The instructions comprise state use determination instructions 522, decryption instructions 524 and record update instructions 526. A signer 506 is also depicted in FIG. 5.

The computing device 500 is to receive, via the interface 502, data 514 comprising an encrypted signature (e.g., corresponding to the encrypted signature 110 of FIG. 1). The data 514 is indicative of a state used by the signer 506 to generate the signature under a stateful signature scheme. For example, the signature may comprise the state or the state may be indicated by another part of the data. The state may or may not be confidential and/or integrity protected, as described above.

The state use determination instructions 522 are to determine whether the state is free to use, as an input to generate a signing key under the stateful signature scheme, by checking whether the state is indicated as being a free state in a record (e.g., a database maintained by the computing device 500). The record is indicative of states that have not yet been used (e.g., by the signer 506 itself or any signer) as an input to generate a signing key under the stateful signature scheme. In some examples, the signer 506 may hold its own record, which may be updated in response to computing device 500 informing the signer 506 about used states.

The decryption instructions 524 are to, in response to determining that the state is free, decrypt the signature.

The record update instructions 526 are to instruct update of the record to indicate that the state is no longer free. Thus, the computing device's 500 record may need to be updated to prevent any signer from reusing a state, hence the need to update such a record. The update of the record may, in some examples, comprise updating the signer's 506 record (if it has one).

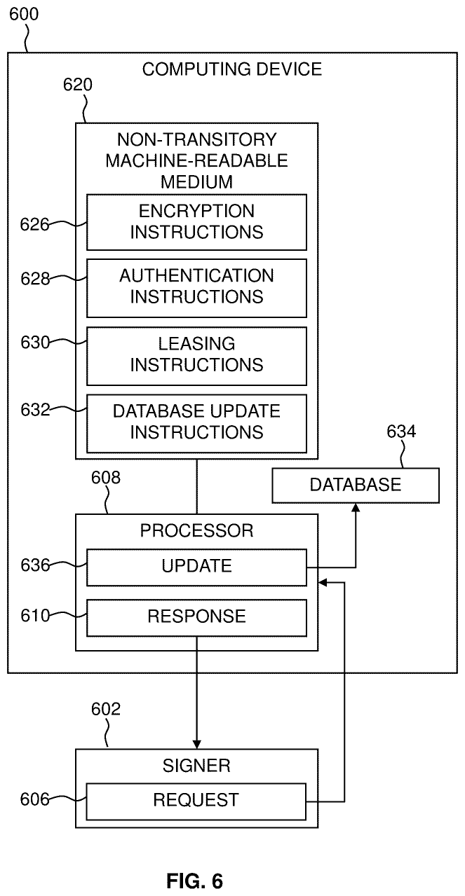

FIG. 6 is a schematic drawing of an example computing device 600 to use a signature transmitted in a stateful signature scheme. Reference numerals for features of the computing device 600 that are similar to or have corresponding functionality to features of the computing device 500 of FIG. 5 are incremented by 100. The computing device 600 may implement similar functionality to the computing device 500 (and provide similar technical results as described previously). Thus, further details of the features of the computing device 600 with similar functionality to the features of the computing device 500 can be understood with reference to the description of the computing device 500 and related examples.

The computing device 600 comprises an interface 602, a processor 604 and a non-transitory machine-readable medium 620. A signer 606 and recipient 608 are also depicted in FIG. 6.

The non-transitory machine-readable medium 620 stores instructions readable and executable by the processor 604.

In some examples, the instructions comprise state verification instructions 628. The state verification instructions 628 are to, prior to the processor 604 determining whether the state has been used previously, verify that the data indicative of the state has not been modified in transit to the computing device 600. If the data indicative of the state has been modified (e.g., by an attacker), the state verification instructions 628 may prevent decryption of the signature in the data 614. However, if the data indicative of the state has not been modified, the state is verified and the decryption of the signature may proceed.

In some examples, the instructions comprise signer inform instructions 630. The signer inform instructions 630 are to, in response to the processor 604 determining that the state is not a free state, inform the signer 606 that the state has been used previously. This may enable the signer 606 to avoid signing messages based on states that are not free, thereby saving resources.

In some examples, the instructions comprise signature verification instructions 632. The signature verification instructions 632 are to verify the signature using: a public key of the signer 606 and the state used by the signer 606 as the input to generate the signature. In response to the verification failing, the processor 604 is to delete the decrypted signature 612 (if the encrypted signature has already been decrypted). In response to the verification being successful, the processor 604 is to instruct transmission of the decrypted signature 612 to the recipient 608 via the interface 602.

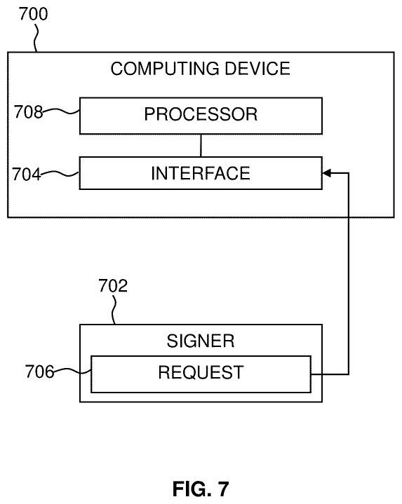

FIG. 7 is a schematic drawing of an example computing device 706 to transmit a signature in a stateful signature scheme. In this example, the computing device 706 corresponds to the signer 106 of FIG. 1 and related examples, in which the signer 106 transmitted an encrypted signature 110. Thus, the computing device 706 may help to facilitate the functionality of the computing device 100 and related examples, which provide the functionality of the state manager.

Reference numerals for features that are similar to or have corresponding functionality to features in FIG. 1 are incremented by 600. The computing device 706 may implement similar functionality to the signer 106 (and facilitate provision of the technical results as described previously). Thus, further details of the features of the computing device 706 with similar functionality to the features of the signer 106 can be understood with reference to the description of the signer 106 and related examples.

The computing device 706 comprises a communication interface 740 and a processor 742. The communication interface 740 may be used to communicate data with an entity 700, which may correspond to a state manager (e.g., the computing device 100 of FIG. 1 and related examples).

The processor 742 is to generate an encrypted signature 744 (e.g., corresponding to the signature 110). The signature 744 is generated using a signing key derived from a candidate state of a stateful signature scheme. The candidate state may correspond to a state that has been speculatively selected by the computing device 706. The computing device 706 does not know if the candidate state is a free state. However, the entity 700 is able to decide whether to accept the signature 744 (and, if appropriate, release a decrypted copy of the signature 744, as described previously).

The processor 742 is to instruct data 746 comprising the encrypted signature 744 to be sent via the communication interface 740 to the entity 700 to determine whether the candidate state is a free state to use to generate the signature 744 under the stateful signature scheme. In some examples, the data 746 may comprise the signature 744 alone (which indicates the candidate state). In some examples, the data 746 may comprise the signature 744 (including the state) and the message that the signature 744 is applied to. In some examples, the data 746 may comprise an indication of the state that is separate to the signature 744. In some examples, such an indication may also be encrypted. In some examples, such an indication may not be encrypted but may be integrity protected e.g., using a signature that is separately generated under a different scheme such as a stateless scheme, or using a MAC.

The processor 742 is further to decide whether to generate another signature based on an indication 748, received via the communication interface 740, of whether the signature 744 has been successfully decrypted by the entity.

In response to the indication 748 indicating that the signature 744 has been successfully decrypted by the entity 700, the processor 742 is to decide that another signature is not to be generated.

In response to the indication 748 indicating that the signature 744 has not been released by the entity 700 (e.g., if the signature 744 is decrypted, verified and then rejected if the candidate state used to derive the signature 744 is not available), the processor 742 is to decide that another signature is to be generated from a different candidate state of the stateful signature scheme.

Thus, if the computing device 706 selects a state that is not free and may result in breakdown of security if released, the indication 748 may inform the computing device 706 so that the computing device 706 may reattempt signing of the message based on a different candidate state.

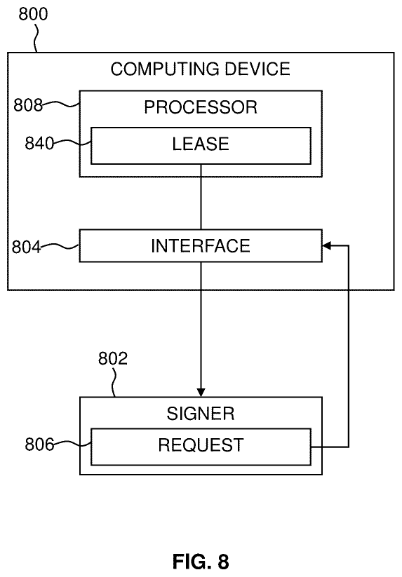

FIG. 8 is a schematic drawing of an example computing device 806 to transmit a signature in a stateful signature scheme. Reference numerals for features of the computing device 806 that are similar to or have corresponding functionality to features of the computing device 706 of FIG. 7 are incremented by 100. The computing device 806 may implement similar functionality to the computing device 706 (and provide similar technical results as described previously). Thus, further details of the features of the computing device 806 with similar functionality to the features of the computing device 706 can be understood with reference to the description of the computing device 706 and related examples.

The computing device 806 comprises a communication interface 840 and a processor 842. Also depicted in FIG. 8 is an entity 800, which may correspond to a state manager (e.g., the computing device 100 of FIG. 1 and related examples).

In some examples, the data 846 is indicative of the candidate state used to derive the signing key.

In some examples, the data 846 is to protect an integrity of the candidate state. For example, the data 846 may be encrypted, signed (e.g., using a separate key to the signing key used to generate the encrypted signature 844) or integrity protected using a MAC.

In some examples, the processor 842 is to obtain an encryption key 848 to encrypt the signature 844. Such an encryption key 848 may be stored in the computing device 806 or otherwise generated on demand e.g., based on a seed value (e.g., different to the private seed value associated with the stateful signature scheme) stored in the computing device 806. The encryption key 848 may be based on a symmetric or asymmetric encryption scheme. The entity 800 may possess the relevant key to decrypt the signature 844.

In some examples, the processor 842 is to generate the encryption key 848 based on the candidate state. For example, the encryption key 848 may be generated by a KDF that has, as its inputs, the candidate state and the seed value.

In some examples, the processor 842 is to update a database 850 holding information on free states to use under the stateful signature scheme in response to being informed by the entity 800, via the communication interface 840, that the candidate state is not a free state. For example, the computing device 806 may receive an indication from the entity 800 that the state is unavailable because it has been used previously e.g., by another signer of the stateful signature scheme. The processor 842 may then provide an update 852 to instruct the database 850 to update its information on the free states to reflect that the state is no longer free. In some examples, the update 852 may be in response to the computing device 806 itself using the state to derive the signature 844.

Any of the blocks, nodes, instructions or modules described in relation to the figures may be combined with, implement the functionality of or replace any of the blocks, nodes, instructions or modules described in relation to any other of the figures. For example, methods may be implemented as machine-readable media or computing devices, machine-readable media may be implemented as methods or computing devices, and computing devices may be implemented as machine-readable media or methods. Further, any of the functionality described in relation to any one of a method, machine readable medium or computing device described herein may be implemented in any other one of the method, machine readable medium or computing device described herein. Any claims written in single dependent form may be re-written, where appropriate, in multiple dependency form since the various examples described herein may be combined with each other.

Examples in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, flash storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing circuitry, or a module thereof, may execute the machine-readable instructions. Thus, functional nodes, modules or apparatus of the system and other devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computing device comprising:
a communication interface; and
a processor to:
determine whether a signature, produced by a signer, is derived from a free state under a stateful signature scheme, wherein the free state is a state that has not been used as an input to generate a signing key, wherein the signature is encrypted by the signer;
in response to determining that the signature is derived from a free state, decrypt the encrypted signature; and
transmit the decrypted signature to a recipient via the communication interface.

2. The computing device of claim 1, wherein the processor is to:
in response to determining that the signature is not derived from a free state, delete the decrypted signature.

3. The computing device of claim 1, wherein the signature is to facilitate verification of a message signed with the signature by the signer.

4. The computing device of claim 3, wherein the message is received via the communication interface along with the encrypted signature, and wherein the processor is to, in response to determining that the signature is derived from a free state, instruct transmission of the message via the communication interface to the recipient.

5. The computing device of claim 3, wherein the processor is to, in response to determining that the signature is derived from a free state, instruct the signer to transmit the message to the recipient.

6. A non-transitory machine-readable medium storing instructions readable and executable by a processor of a computing device to:
receive, via an interface of the computing device, data comprising an encrypted signature, wherein the data is indicative of a state used by a signer to generate the signature under a stateful signature scheme;
determine whether the state is free to use, as an input to generate a signing key under the stateful signature scheme, by checking whether the state is indicated as being a free state in a record, wherein the record is indicative of states that have not yet been used as an input to generate a signing key under the stateful signature scheme;
in response to determining that the state is free, decrypt the signature; and
instruct update of the record to indicate that the state is no longer free.

7. The non-transitory machine-readable medium of claim 6, wherein the processor is to:
prior to determining whether the state has been used previously, verify that the data indicative of the state has not been modified in transit to the computing device.

8. The non-transitory machine-readable medium of claim 6, wherein the processor is to:
in response to determining that the state is not a free state, inform the signer that the state has been used previously.

9. The non-transitory machine-readable medium of claim 6, wherein the processor is to verify the signature using: a public key of the signer and the state used by the signer as the input to generate the signature, wherein:
in response to the verification failing, the processor is to delete the decrypted signature; or
in response to the verification being successful, the processor is to instruct transmission of the decrypted signature to a recipient via the interface.

10. A computing device comprising:
a communication interface; and
a processor to:
generate an encrypted signature, wherein the signature is generated using a signing key derived from a candidate state of a stateful signature scheme;
instruct data comprising the encrypted signature to be sent via the communication interface to an entity to determine whether the candidate state is a free state to use to generate the signature under the stateful signature scheme; and
decide whether to generate another signature based on an indication, received via the communication interface, of whether the signature has been successfully decrypted by the entity, wherein:
in response to the indication indicating that the signature has been successfully decrypted by the entity, the processor is to decide that another signature is not to be generated; or
in response to the indication indicating that the signature has not been released by the entity, the processor is to decide that another signature is to be generated from a different candidate state of the stateful signature scheme.

11. The computing device of claim 10, wherein the data is indicative of the candidate state used to derive the signing key.

12. The computing device of claim 11, wherein the data is to protect an integrity of the candidate state.

13. The computing device of claim 10, wherein the processor is to obtain an encryption key to encrypt the signature.

14. The computing device of claim 13, wherein the processor is to generate the encryption key based on the candidate state.

15. The computing device of claim 10, wherein the processor is to update a database holding information on free states to use under the stateful signature scheme in response to being informed by the entity, via the communication interface, that the candidate state is not a free state.
